(19) United States
(12) Patent Application Publication
(10) Pub. No.: US 2014/0357545 A1
(43) Pub. Date: Dec. 4, 2014

(54) Mermaid Spit

(71) Applicant: Denise Meagher, York, ME (US)

(72) Inventor: Denise Meagher, York, ME (US)

(21) Appl. No.: 14/280,859

(22) Filed: May 19, 2014

Related U.S. Application Data
(60) Provisional application No. 61/828,438, filed on May 29, 2013.

(51) Int. Cl. C09G 1/18

(52) U.S. Cl. CPC C09G 1/18
USPC 510/400

(57) ABSTRACT

A polish composition and method of making the same is disclosed. The polish composition comprises equal parts of petroleum jelly and mineral oil. Furthermore, the petroleum jelly is melted into the mineral oil and dissolved, and then the composition is applied to a watercraft surface. The polish composition erases oxidation, restores color, and polishes the surface of a boat, watercraft, or any fiberglass, plastic, or metal surface.

### CROSS-REFERENCE

This application claims priority from Provisional Patent Application Ser. No. 61/828,438 filed May 29, 2013.

### BACKGROUND

Currently existing products for oxidizing, polishing, and restoring color to a boat or similar object tend to be expensive, time-consuming and harsh. Such products take several hours to work, utilize costly ingredients, and can be harmful to individuals, paint job surfaces, and the environment. Additionally, such products cannot extend the life of a watercraft surface, repel water, and prevent the accumulation of rust, corrosion and mineral build-up. Thus, an effective solution is necessary.

The present invention erases oxidation, restores color, and polishes the surface of a boat, watercraft, or any fiberglass, plastic, or metal surface, and works instantly to greatly decrease the time spent cleaning and polishing a surface area. The polish composition allows for application in all weather conditions, and reduces the cost of maintaining the condition and appearance of a boat's surface. The polish composition utilizes a non-toxic, environmentally safe formula with a low coefficient of friction, and leaves behind little to no residue.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a polish composition and method of making the same. The polish composition comprises equal parts of petroleum jelly and mineral oil. Additionally, other additives or fragrances may be added to the composition as is known in the art.

Furthermore, in a preferred embodiment, a method of preparing the polish composition is disclosed, wherein between 0 and about 0.5 percent by weight of petroleum jelly is mixed with between 0 and about 0.5 percent by weight of mineral oil. The method continues with the petroleum jelly being melted into the mineral oil until they are dissolved together, and then the composition is applied to a watercraft surface.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a flow chart of the method steps of preparing the polish composition in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention erases oxidation, restores color, and polishes the surface of a boat, watercraft, or any fiberglass, plastic, or metal surface, and works instantly to greatly decrease the time spent cleaning and polishing a surface area. The polish composition allows for application in all weather conditions, and reduces the cost of maintaining the condition and appearance of a boat's surface. The polish composition utilizes a non-toxic, environmentally safe formula with a low coefficient of friction, and leaves behind little to no residue.

The polish composition comprises equal parts petroleum jelly and mineral oil. Furthermore, the petroleum jelly is melted into the mineral oil and dissolved, and then the composition is applied to a watercraft, or any fiberglass, plastic, or metal surface. The polish composition extends the life of a watercraft surface, repels water, and prevents the accumulation of rust, corrosion and mineral build-up.

The polish composition of the present invention is adapted for use on painted metallic and fiberglass or plastic surfaces. In particular, it is effective for automobile, trucks, boat, and watercraft bodies. Other applications for the polish are still being developed, but it is anticipated that the polish can be used on many types of painted metallic and fiberglass or plastic surfaces in order to improve the surface's color as well as the surface's resistance to oxidation, and to prevent the accumulation of rust or corrosion.

The polish is effective in removing dirt, dust, grime and oxidation. Furthermore, once applied, the polish leaves a protective layer (or film layer) on the treated surface. This protective layer acts as a barrier to protect the surface against damage from salt water and other corrosive agents, and protects against discoloration. Thus, the polish restores the original luster to the dull or faded surfaces by the interaction of the polish with the surface itself. It is believed that the polish removes oxidation on the surface and then adheres to the surface creating the protective layer.

The polish comprises: petroleum jelly and mineral oil in equal parts. The mineral oil can be any transparent, colorless oil composed mainly of alkanes and cyclic paraffins. The petroleum jelly can be any suitable semi-solid mixture of hydrocarbons. The polish composition may further comprise additives, fragrances, or polymers, or any other suitable agents as is known in the art without affecting the overall concept of the invention.

Preferably, the polish composition comprises petroleum jelly in an amount between about 0 and about 0.5 percent by weight of the polish composition; and mineral oil in an amount between about 0 and about 0.5 percent by weight of the polish composition, though any other suitable percentages can be used as is known in the art. The preferred formula is: 0.5 percent of petroleum jelly and 0.5 percent of mineral oil by weight. Typically, the petroleum jelly is melted into the mineral oil until its dissolved to form the composition. The polish composition then forms a cloudy white, opaque fluid that is odorless and leaves no white residue when applied. The polish composition penetrates the surface quickly, is non-abrasive, and has a low coefficient of friction.

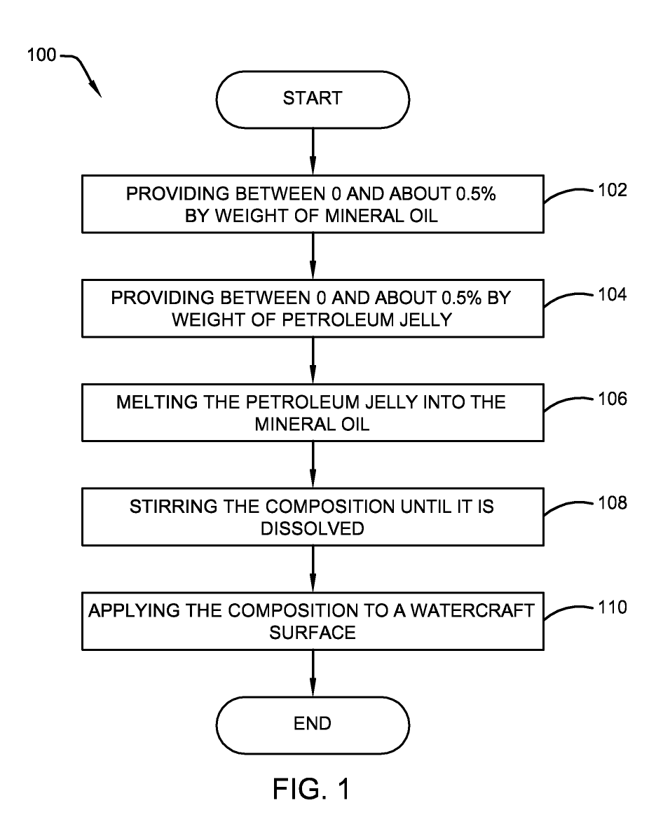

Referring to FIG. 1, a method 100 for preparing the polish composition is disclosed. The polish composition should be formulated in the following manner in order to obtain maximum efficacy. Using the preferred polish composition, in a first vessel or container, the user should pour in about 0.5 percent by weight of mineral oil at 102 and, then, the user should pour in about 0.5 percent by weight of petroleum jelly in the same vessel at 104. The two components are then melted together at 106 and agitated (or stirred together) until completely dissolved to form the composition at 108. Once the polish composition is formed, a user can apply the polish to a watercraft or other suitable surface by hand at 110 using a clean, dry, lint-free cloth. The hand motion should be a firm circular motion. A user would then use a separate dry, lint-free cloth to remove any excess composition when finished. The consistency of the polish composition allows it to be either poured onto the surface or sprayed with a pump, or any other suitable dispensing means can be used to apply the polish composition to the surface to be polished.

Furthermore, the polish composition can be applied in all weather conditions and can come in different sizes such as 8 fl. oz. or 1 gallon increments. An eight ounce bottle of polish will typically cover about two standard size vehicles or watercrafts. The polish, once applied, leaves a protective layer that serves as a protectant against corrosive agents, such as salt water.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A polish composition, comprising:
equal parts of petroleum jelly and mineral oil.

2. The polish composition of claim 1, wherein the petroleum jelly and the mineral oil are melted together to form the composition.

3. The polish composition of claim 2, comprising petroleum jelly in an amount between about 0 and about 0.5 percent by weight of the polish composition.

4. The polish composition of claim 3, comprising mineral oil in an amount between about 0 and about 0.5 percent by weight of the polish composition.

5. The polish composition of claim 1, wherein the composition comprises a low coefficient of friction.

6. The polish composition of claim 1, wherein the composition is poured onto surfaces to be polished.

7. The polish composition of claim 1, wherein the composition is sprayed with a pump onto surfaces to be polished.

8. The polish composition of claim 1, wherein the composition can be applied in all weather conditions.

9. The polish composition of claim 1, wherein the composition is odorless and leaves no white residue.

10. The polish composition of claim 1, wherein the composition leaves a protective layer on a surface to be polished which protects against corrosive agents.

11. A polish composition, comprising:
petroleum jelly in an amount between about 0 and about 0.5 percent by weight of the polish composition; and
mineral oil in an amount between about 0 and about 0.5 percent by weight of the polish composition.

12. The polish composition of claim 11, wherein the petroleum jelly and the mineral oil are melted together to form the solution.

13. The polish composition of claim 12, wherein the composition comprises a low coefficient of friction.

14. The polish composition of claim 12, wherein the composition can be applied in all weather conditions.

15. The polish composition of claim 12, wherein the composition is odorless and leaves no white residue.

16. The polish composition of claim 12, wherein the composition is poured onto surfaces to be polished.

17. The polish composition of claim 12, wherein the composition is sprayed with a pump onto surfaces to be polished.

18. The polish composition of claim 12, wherein the composition leaves a protective layer on a surface to be polished which protects against corrosive agents.

19. A method of preparing a polish composition for polishing a watercraft, the method comprising:
providing between 0 and about 0.5 percent by weight of mineral oil;
providing between 0 and about 0.5 percent by weight of petroleum jelly;
melting the petroleum jelly into the mineral oil; and
stirring the composition until it is dissolved.

20. The method of claim 19, further comprising the step of applying the composition to a watercraft surface.
